(19) United States
(12) Patent Application Publication
(10) Pub. No.: US 2013/0076880 A1
(43) Pub. Date: Mar. 28, 2013

(54) IMAGE PROCESSING METHOD AND IMAGE CAPTURING SYSTEM

(71) Applicants: KULDEEP KUMAR SAXENA, SINGAPORE (SG); TONG TEE TAN, SINGAPORE (SG); NELSON YII KON, SINGAPORE (SG)

(72) Inventors: KULDEEP KUMAR SAXENA, SINGAPORE (SG); TONG TEE TAN, SINGAPORE (SG); NELSON YII KON, SINGAPORE (SG)

(73) Assignee: LITE-ON SINGAPORE PTE. LTD., MIDVIEW CITY (SG)

(21) Appl. No.: 13/241,459

(22) Filed: Sep. 23, 2011

(51) Int. Cl. H04N 7/18; G06K 9/00

(52) U.S. Cl. 348/77; 382/124; 348/E05.024

(57) ABSTRACT

An image processing method includes the following steps. The first step is utilizing a linear image capturing apparatus with odd number of image capturing units to capture image portions of object. Next step is taking the image portions which are captured by the first-end and the right-end image capturing units as the reference and comparing the image portions which are captured by the central image capturing units with the reference so as to correct and eliminate the overlapped noise. Next step is interlacing and re-constructing the processed image portions which have no overlapped portions as the integrated image.

### BACKGROUND OF THE INVENTION

1. Field of the Invention

The present invention relates to animage processing method and an image capturing system. In particular, the present invention relates to a fingerprint image processing method and an image capturing system utilizing the same.

2. Description of Related Art

Traditional formats of security code, such as a computer password, may include alphabet, characters, and Arabic numerals. Now, the biometric recognition technique has developed and applied to personal media protection. Particularly, the biometric features, such as fingerprint or other biometric recognition data are recognized to generate a unique security code.

A traditional method to recognize the fingerprint is printing the fingerprint on a paper by means such as colored inks; then, the printed image is scanned to and stored as digital information. The scanned image may then be compared with a data base for recognition in order to authorize the access rights. However, the method cannot meet the requirement of the real-time recognition for electronic commerce, interne data recognition, security of portable electronic device or personal identification security.

For recognizing fingerprint real-time, fingerprint recognition apparatus has been developed. For example, the optical fingerprint sensor is used to read and recognize the fingerprint immediately. However, the optical fingerprint sensor has lenses or optical devices with a large dimension. In other words, the fingerprint recognition has large size which cannot be applied in the small-size electronic products. Moreover, the large lenses may have structural interfere with other parts.

### SUMMARY OF THE INVENTION

One objective of the instant disclosure is to provide an image processing method capable of solving the overlapped issue of the images captured by adjacent capturing units so as to improve the captured image quality of the image capturing system. It is also an objective of the instant disclosure to provide animage capturing system having compact dimension. The manufacturing procedure of the image capturing system of the instant disclosure is not complex so that the manufacturing cost can be reduced.

The instant disclosure provides animage processing method. The method includes the steps of:

Step 1 is providing an image capturing apparatus. The image capturing apparatus includes a left-end capturing unit, a right-end capturing unit and at least one central capturing unit arranged between the left-end capturing unit and the right-end capturing unit. The image capturing apparatus is a linear image capturing apparatus, and the number of the left-end capturing unit, the right-end capturing unit and the central capturing unit is odd.

Step 2 is capturing images of an object sliding on the image capturing apparatus. The left-end capturing unit captures an image frame of a left end of the object, and the captured image frame of the left end of the object has opposite non-overlapped end and overlapped end. The right-end capturing unit captures an image frame of a right end of the object, and the captured image frame of the right-end of the object has opposite non-overlapped end and overlapped end. The central capturing unit captures at least one image frame of at least one middle portion of the object between the left and the right end, and the captured image frame of the middle portion of the object each has opposite overlapped ends.

Step 3 is processing the captured image frames of the left end, the right end and the middle portion of the object to eliminate the overlapped ends thereof.

Step 4 is constructing the processed image frames of the left end, the right end and the middle portion of the object without overlapped ends to form a complete image frame of the object.

The instant disclosure provides an image capturing system. The image capturing system comprises an image capturing apparatus, a microprocessor and a storing device. The image capturing apparatus includes a left-end capturing unit, a right-end capturing unit and at least one central capturing unit arranged between the left-end capturing unit and the right-end capturing unit, which is a linear image capturing apparatus. The number of the left-end capturing unit, the right-end capturing unit and the central capturing unit is odd. The microprocessor is electrically coupled to the image capturing apparatus. The storing device is electrically coupled to the microprocessor.

The image capturing apparatus of the instant disclosure is a compact linear sensor with odd capturing units; therefore, the size of the product can be reduced. For solving the overlapped issue of the images captured by adjacent capturing units, the instant disclosure provides an image processing method for obtaining the improved image. In the fingerprint recognition, the instant disclosure is applied to obtain clear image of fingerprint with no overlapped image portions.

For further understanding of the present invention, reference is made to the following detailed description illustrating the embodiments and examples of the present invention. The description is for illustrative purpose only and is not intended to limit the scope of the claim.

### BRIEF DESCRIPTION OF THE DRAWINGS

FIG. 1 shows the image capturing system of the instant disclosure.

FIG. 2 shows the image capturing apparatus of the image capturing system according to the instant disclosure.

FIG. 3(a)-(c) shows the structural diagram of the image processing method according to the instant disclosure.

FIG. 4 shows the flow chart of the image processing method according to the instant disclosure.

### DETAILED DESCRIPTION OF THE PREFERRED EMBODIMENTS

The instant disclosure provides animage capturing system utilizing a plurality of linearly-arranged capturing units to capture the image of an object. The size and the manufacturing cost of the image capturing system are small. In addition, the instant disclosure provides an image processing method to solve the overlapped issue of the images captured by adjacent capturing units.

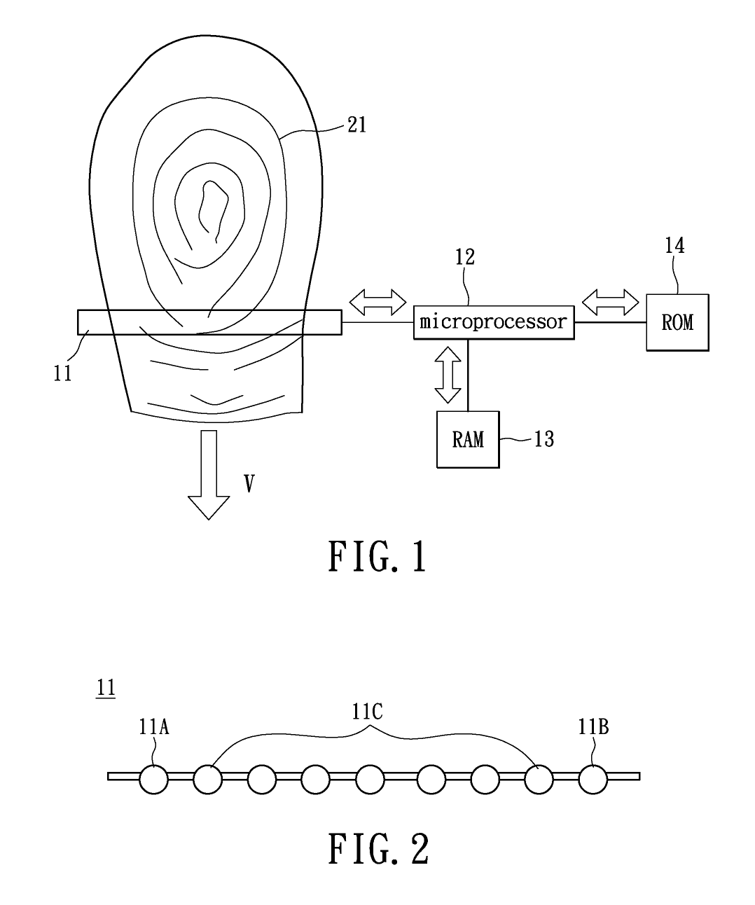

Please refer to FIG. 1; the image capturing system at least has an image capturing apparatus 11, a microprocessor 12 and a storing device. Referring to FIG. 2, the image capturing apparatus 11 includes an odd number of linearly-arranged capturing units. Specifically, the image capturing apparatus 11 includes a left-end capturing unit 11A, a right-end capturing unit 11B and at least one central capturing unit 11C. The number of the central capturing unit 11C is preferably an odd number, and the central capturing unit 11C is arranged between the left-end capturing unit 11A and the right-end capturing unit 11B to form a liner image capturing apparatus 11. In the exemplary embodiment, the left-end capturing unit 11A, the right-end capturing unit 11B and the central capturing unit 11C are substantially identical, for example, they are fingerprint sensors which include a plurality of optical sensing devices, such as CMOS devices. Alternatively, they may be electric-capacity type sensing devices, pressure type sensing devices, or temperature type sensing devices. The signals obtained by the above-mentioned sensing devices may be transferred to practice the image processing method of the instant disclosure.

Please refer to FIG. 1 again; the image capturing system is used to capture the fingerprint 21 of a user in the exemplary embodiment. As shown in FIG. 1, the finger of the user may slide over the image capturing apparatus 11 for obtaining optical fingerprint data (i.e., image) of the finger. The microprocessor 12 is used to process the fingerprint data and re-construct the image of fingerprint 21. The storing device is used to store data, images or software. For example, the storing device may include ROM 14 and RAM 13. ROM 14 is electrically coupled to the microprocessor 12 and capable for storing image processing software or image processing mechanism. Thus the microprocessor 12 may activate the software or mechanism to process the fingerprint data. RAM 13 is capable for storing the captured fingerprint data and/or the processed fingerprint images.

Please refer to FIG. 2; when the finger slides on the image capturing apparatus 11, the left-end capturing unit 11A, the right-end capturing unit 11B and the central capturing unit 11C are used to image frames of the fingerprint 21. Then, the microprocessor 12 activates the image processing software or image processing mechanism to execute the method for eliminating the overlapped portion which is captured by the adjacent capturing units. Afterwards, the image frames can be re-combined to form the complete image frame of the fingerprint.

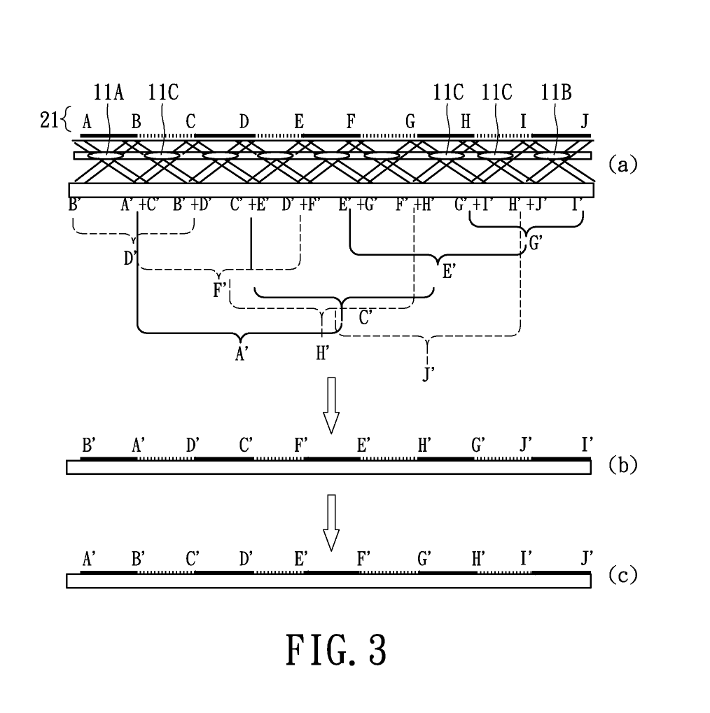

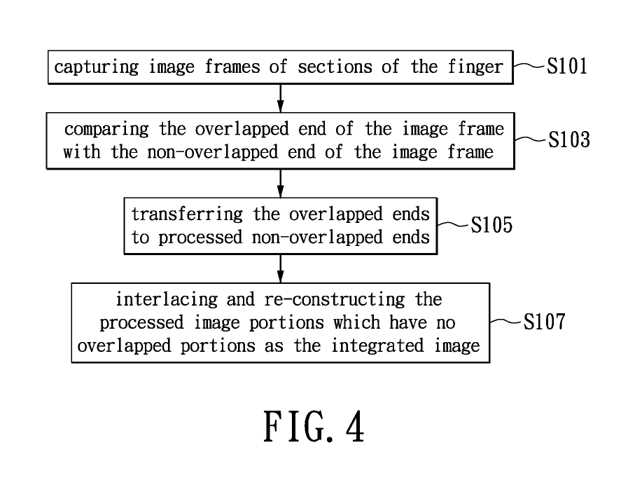

Please refer to FIGS. 3 and 4; the image capturing apparatus 11 is used to capture the image frame of the sliding finger. As shown in FIG. 1, the finger and the image capturing apparatus 11 has a relative velocity“V” so that the image capturing apparatus 11 can capture the continuous images of the fingerprint 21. Please note that the number of the central capturing unit 11C in the exemplary embodiment is 7(seven) and the total member of the capturing units of 11A, 11B and 11C is 9 (night). For simplicity, the capturing units of 11A, 11B and 11C are represented by lens in the drawing.

As Step S101 shown in FIG. 4, the capturing units of 11A, 11B and 11C are used to capture the image frames of the sliding object, i.e., the finger. As shown in FIG. 3, the fingers are optically separated as section“AB”, section“BC”, section“CD” thru section“IJ” corresponding to the capturing units of 11A, 11B and 11C. The left-end capturing unit 11A captures an image frame of a left end of the object and the right-end capturing unit captures an image frame of a right end of the object. In detail, the image frame of section “AB” of the finger is captured by the left-end capturing unit 11A and the image frame of section “IJ” of the finger is captured by the right-end capturing unit 11B. The image frame of sections“BC” thru “HI” are respectively captured by the central capturing units 11C. Please note that “A” thru “J” represent the end of the sections of the object (i.e., the finger) and A′ thru J′ represent the image of the end of the sections captured by the corresponding lens.

Please refer to FIG. 3 (a); the sections of the finger are imaged through the capturing units of 11A, 11B and 11C and then stored in the RAM 13. As shown in FIG. 3 (a), the image frame of the section “AB” (i.e., the left end of the finger) is captured by the left-end capturing unit 11A and has a non-overlapped end and an overlapped end. For example, the non-overlapped end of the image frame of the section “AB” is B′ and the overlapped end of the image frame of the section “AB” is A′+C′ which is combined by the image A′ captured by the left-end capturing unit 11A and the image C′ captured by the central capturing unit 11C which is adjacent to the left-end capturing unit 11A. Similarly, the image frame of the section “IJ” (i.e., the right end of the finger) is captured by the right-end capturing unit 11B and has a non-overlapped end and an overlapped end. For example, the non-overlapped end of the image frame of the section “IJ” is I′ and the overlapped end of the image frame of the section “IJ” is J′+H′ which is combined by the image J′ captured by the right-end capturing unit 11B and the image H′ captured by the central capturing unit 11C which is adjacent to the right-end capturing unit 11B.

On the other hand, the captured image frame of the middle portion of the finger each has opposite overlapped ends. For example, the image frame of the section “BC” (i.e., one of the middle portions of the finger) is captured by the first central capturing units 11C and has overlapped ends. In detail, one overlapped end of the image frame of the section “BC” is C′+A′which is combined by the image C′ captured by the first central capturing units 11C and the image A′ captured by the left-end capturing unit 11A. The other overlapped end of the image frame of the section “BC” is B′+C′ which is combined by the image B′ captured by the first central capturing units 11C and the image D′ captured by the second central capturing unit 11C which is adjacent to the first central capturing units 11C.

As shown in FIG. 4, Step S103 is processing the captured image frames of the left end, the right end and the middle portion of the finger to eliminate the overlapped ends thereof. In this step, the non-overlapped end and the overlapped end are compared to calculate/eliminate the overlapped ends. In the exemplary, the captured image frames stored in the RAM 13 can be processed to compare with each other to calculate/eliminate the overlapped ends when the microprocessor 12 activates the software or mechanism stored in the ROM 14.

In further detail, the non-overlapped end of the image frame captured by the capturing unit 11A can be processed to compare to the overlapped end of image frame captured by the central capturing units 11C so as to transfer the overlapped end of image frame to the non-overlapped end of the image frame. For example, in conjunction with the non-overlapped end B′ of the image frame of the section “AB”, the overlapped end B′+D′ of the image frame captured by the central capturing unit 11C is selected by the microprocessor 12 to process and calculate by a subtraction mechanism stored in ROM 14. In detail, the overlapped end B′+D′ is subtracted from non-overlapped end B′ so as to obtain a processed non-overlapped end D′. Similarly, in conjunction with the non-overlapped end I′ of the image frame of the section “IJ”, the overlapped end G′+I′ of the image frame captured by the central capturing unit 11C is selected by the microprocessor 12 to process and calculate by a subtraction mechanism stored in ROM 14. In detail, the overlapped end G′+I′ is subtracted from non-overlapped end I′ so as to obtain a processed non-overlapped end G′. Therefore, the overlapped end G′+I′ and B′+D′ are respectively calculated to transfer to processed non-overlapped ends G′ and D′ after the first-order process.

Next, the rest overlapped ends are compared to the corresponding non-overlapped end in the following processing and calculation. In other words, the processed non-overlapped ends further are used to compare with the overlapped ends of the rest image frames. For example, in conjunction with the processed non-overlapped end D′ of the image frame, the overlapped end D′+F′ of the image frame captured by the central capturing unit 11C is selected by the microprocessor 12 to process and calculate by a subtraction mechanism stored in ROM 14 to obtain a processed non-overlapped end F′. By repeating the comparing process, all the overlapped ends of the image frames can be transferred to non-overlapped ends and the image frames having processed non-overlapped ends may be stored in RAM 13.

Next step is interlacing or constructing the processed image frames of the left end, the right end and the middle portion of the object without overlapped ends to form a complete image frame of the finger (S105 and S107). In detail, the processed image frames are re-arranged depending on the pixel number, sequence defined by the capturing units of 11A, 11B and 11C as shown in FIG. 3 (b). Furthermore, the re-arranged image frames are rotated and re-construct as a complete image frame of the finger, as shown in FIG. 3 (C).

Accordingly, the image capturing system has odd-number, linearly-arranged capturing units to capture the image of the object. The size and the cost are lower. Furthermore, the image comparing and processing methods are used to eliminate the overlapped issue efficiently.

To sum up, the present invention at least has the following characteristics.

1. The method and system of the instant disclosure may be used in fingerprint recognition and the processed image of the fingerprint is with no undesired overlapped noise which is filtered out according to the instant image processing method. In other words, the processed image of the fingerprint is precise to execute the access recognition.

2. The traditional lenses with large dimensions are not necessary in the instant image capturing system. Thus, the manufacturing cost of the instant image capturing system is reduced. Furthermore, the instant method may be applied to the instant image capturing system to improve the image quality, which can improve the recognition rate.

The description above only illustrates specific embodiments and examples of the present invention. The present invention should therefore cover various modifications and variations made to the herein-described structure and operations of the present invention, provided they fall within the scope of the present invention as defined in the following appended claims.

What is claimed is:

1. An image processing method comprising the steps of:
providing an image capturing apparatus, wherein the image capturing apparatus includes a left-end capturing unit, a right-end capturing unit and at least one central capturing unit arranged between the left-end capturing unit and the right-end capturing unit as a linear image capturing apparatus, the number of the left-end capturing unit, the right-end capturing unit and the central capturing unit is odd;
capturing images of an object sliding pass the image capturing apparatus, wherein the left-end capturing unit captures an image frame of a left end of the object, the captured image frame of the left end of the object has opposite non-overlapped end and overlapped end, the right-end capturing unit captures an image frame of a right end of the object, the captured image frame of the right-end of the object has opposite non-overlapped end and overlapped end, the central capturing unit captures at least one image frame of at least one middle portion of the object between the left and the right end, the captured image frame of the middle portion of the object each has opposite overlapped ends;
processing the captured image frames of the left end, the right end and the middle portion of the object to eliminate the overlapped ends thereof; and
constructing the processed image frames of the left end, the right end and the middle portion of the object without overlapped ends to form a complete image frame of the object.

2. The method as claimed in claim 1, wherein in the step of processing the captured image frames, the overlapped end of the captured image frame of the middle portion which is next to the left end is compared to the non-overlapped end of the captured image frame of the left end to process the overlapped end of the captured image frame of the middle portion to a processed non-overlapped end thereof.

3. The method as claimed in claim 2, wherein in the step of processing the captured image frames, the overlapped end of the captured image frame of the middle portion which is second next to the left end is further compared to the processed non-overlapped end.

4. The method as claimed in claim 3, wherein the non-overlapped end is compare to the overlapped end by a subtraction mechanism.

5. The method as claimed in claim 4, wherein after the step of processing the captured image frames, the captured image frames of the left end, the middle portion and the right end have opposite non-overlapped ends.

6. The method as claimed in claim 4, further comprising a step for rotating and arranging the processed image frames of the left end, the right end and the middle portion of the object before the step of constructing the processed image frames to form a complete image frame of the object.

7. An image capturing system comprising:
an image capturing apparatus, wherein the image capturing apparatus includes a left-end capturing unit, a right-end capturing unit and at least one central capturing unit arranged between the left-end capturing unit and the right-end capturing unit as a linear image capturing apparatus, the number of the left-end capturing unit, the right-end capturing unit and the central capturing unit is odd;
a microprocessor electrically coupled to the image capturing apparatus; and
a storing device electrically coupled to the microprocessor.

8. The image capturing system as claimed in claim 7, wherein the left-end capturing unit, the right-end capturing unit and the central capturing unit each is a fingerprint sensor.

9. The image capturing system as claimed in claim 8, wherein the fingerprint sensor includes a plurality of optical sensing devices.

10. The method as claimed in claim 7, wherein the storing device has image processing software or image processing mechanism stored there inside.
